(19) United States
(12) Patent Application Publication
(10) Pub. No.: US 2005/0077782 A1
(43) Pub. Date: Apr. 14, 2005

(54) Electrically driven parking brake device

(75) Inventors: Takehiro Horiuchi, Wako-shi (JP); Osamu Yamamoto, Wako-shi (JP); Kiyotaka Minoura, Wako-shi (JP); Kunimichi Hatano, Wako-shi (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 10/941,750

(22) Filed: Sep. 15, 2004

(30) Foreign Application Priority Data
Oct. 8, 2003 (JP) 2003-349009

(51) Int. Cl. B60T 13/66

(52) U.S. Cl. 303/20

(57) ABSTRACT

An electrically driven parking brake device includes a ratchet mechanism for restricting movement in a brake releasing direction of a piston which is operated by an electrically driven motor to generate a braking force. In the ratchet mechanism, a ratchet wheel is temporarily rotated in a braking direction to disengage a ratchet pole from the ratchet wheel, thereby releasing the braking force. Even when the electrically driven motor fails to be unable to release the braking force, a manually operated bolt presses the ratchet pole to disengage the ratchet pole from the ratchet wheel, thereby releasing the braking force. Thus, the situation where the vehicle cannot move can be avoided, even when the electrically driven parking brake device is held in operation due to motor failure or the like.

### TECHNICAL FIELD

The present invention relates to an electrically driven parking brake device for driving a braking member which drives a braked member rotating with wheels via an electrically driven motor.

### BACKGROUND ART

In an electrically driven parking brake device disclosed as a third embodiment in FIG. 9 and FIG. 10 of Japanese Patent Application Laid-open No. 2003-42199, a brake lock mechanism for holding a piston generating a braking force in a braking position includes a ratchet wheel and an engaging claw, and when the electrically driven parking brake device is held in an operating state, the engaging claw is engaged with the ratchet wheel with a solenoid to inhibit the retreat of the piston, and when the operation of the electrically driven parking brake device is released, the frictional force between the engaging claw and the ratchet wheel is released by temporarily rotating the ratchet wheel in the braking direction with a motor, and the engaging claw is pulled by the resilient force of a tension spring to be disengaged from the ratchet wheel.

The electrically driven parking brake device described in Japanese Patent Application Laid-open No. 2003-42199 needs to drive the motor in order to release the operation of the electrically driven parking brake device, leading to a problem that the operation of the electrically driven parking brake device cannot be released in such a case where the motor fails in the operation state of the electrically driven parking brake device.

### SUMMARY OF THE INVENTION

The present invention has been achieved in view of the aforementioned circumstances, and an object of the invention is to make it possible to release a braking operation without hindrance even when the motor for releasing the operation of the electrically driven parking brake device fails.

In order to achieve the above-described object, according to a first aspect of the invention, there is provided an electrically driven parking brake device comprising: a braking member which applies a braking force to a braked member rotating with wheels; an electrically driven motor; a driving force transmitting mechanism which connects the motor and the braking member, moves the braking member in a braking direction by drive of the motor, and moves the braking member in a brake releasing direction with a reaction force from the braked member; a braking force holding mechanism which restrains the driving force transmitting mechanism to restrict movement of the braking member in the brake releasing direction; operation of the braking force holding mechanism being released by driving the motor when the braking force holding mechanism is operated to restrain the movement of the braking member in the brake releasing direction; and a manual releasing mechanism which may be manually operated to release the operation of the braking force holding mechanism at a time of failure of the motor.

According to a second aspect of the invention, in addition to the first aspect, the braking force holding mechanism includes a ratchet pole engageable with a ratchet wheel of the driving force transmitting mechanism, and the manual releasing mechanism comprises a manually movable member which disengages the ratchet pole from the ratchet wheel.

A brake disc 13 in an embodiment corresponds to the braked member of the present invention, a brake piston 15 in the embodiment corresponds to the braking member of the present invention, a bolt 45 in the embodiment corresponds to the manually movable member of the manual releasing mechanism of the present invention, a planetary gear mechanism P in the embodiment corresponds to the driving force transmitting mechanism of the present invention, and a ratchet mechanism R in the embodiment corresponds to the braking force holding mechanism of the present invention.

According to the first aspect of the invention, in the electrically driven parking brake device wherein the braking force is released by driving the electrically driven motor to release the operation of the braking force holding mechanism for restricting the movement of the braking member in the brake releasing direction, the braking force can be released by manually driving the braking force holding mechanism through the manual releasing mechanism even if the braking force cannot be released because the electrically driven motor has failed, thus avoiding the situation where the vehicle cannot be moved with the electrically driven parking brake device held in operation.

According to the second aspect of the invention, the braking force holding mechanism includes the ratchet pole engageable with the ratchet wheel of the driving force transmitting mechanism for transmitting the driving force of the motor to the braking member, and the ratchet pole is driven by the manually movable member (bolt) and disengaged from the ratchet wheel, whereby the operation of the electrically driven parking brake device can be easily released even if the electrically driven motor fails.

The above and other objects, features and advantages of the invention will become apparent from the following description of the present embodiment taken in conjunction with the accompanying drawings. It should be understood, however, that the detailed description of a specific example, while indicating the present embodiment of the invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 to FIG. 7 show one embodiment of the present invention, wherein:

FIG. 1 is a cross-sectional view of an electrically driven brake device having a function of an electrically driven parking brake device;

FIG. 2 is a sectional view taken along the line 2-2 in FIG. 1;

FIG. 3 is a sectional view taken along the line 3-3 in FIG. 1;

FIG. 4 is an explanatory view of an operation at a time of operation of the electrically driven parking brake;

FIG. 5 is an explanatory view of an operation at a time of forceful release of the operation of the electrically driven parking brake via the manual releasing mechanism;

FIG. 6 is a time chart at a time of an operation of the electrically driven parking brake; and

FIG. 7 is a time chart at a time of the forceful release of the operation of the electrically driven parking brake.

### DETAILED DESCRIPTION OF THE PRESENT EMBODIMENT

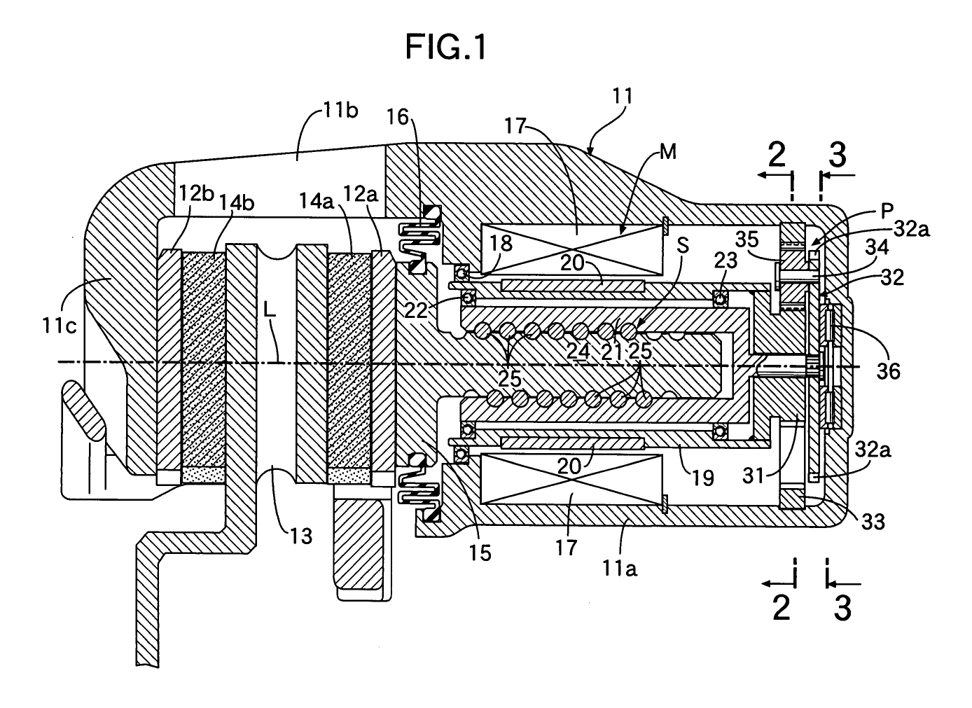

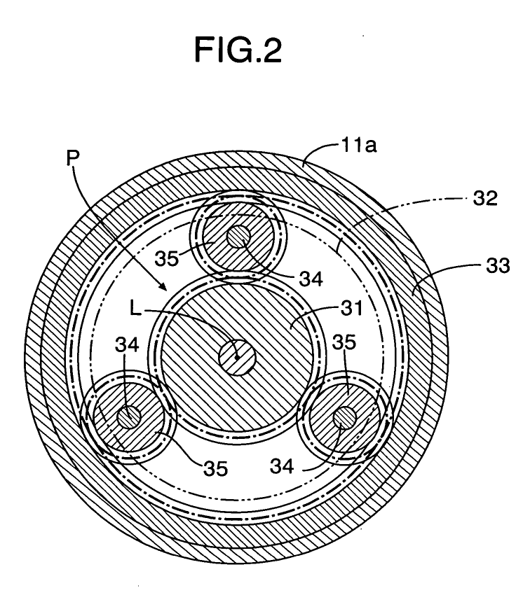

As shown in FIG. 1 to FIG. 3, the electrically driven brake device, also usable as the electrically driven parking brake device, includes a brake caliper 11 which is supported by a knuckle or the like movably in a left and right direction in FIG. 1. Brake pads 14a and 14b, which are capable of abutting to opposite side surfaces of a brake disc 13 fixed to a wheel, are provided on opposing surfaces of a pair of back plates 12a and 12b supported at the brake caliper 11 with guide means (not shown) so that back plates 12a and 12b can move close to and away from each other. A brake piston 15 is supported at a body portion 11a of the brake caliper 11 so as to be able to advance and retreat. A rear surface of the one back plate 12a is pressed with the brake piston 15, the brake caliper 11 is moved in the right direction in FIG. 1 with the reaction force, and an arm portion 11c, which is connected to the body portion 11a of the brake caliper 11 via a bridge portion 11b, presses a rear surface of the other back plate 12b, whereby both the brake pads 14a and 14b abut to the opposite side surfaces of the brake disc 13 to generate a braking force. A dust protective boot 16 is mounted between the brake piston 15 and the brake caliper 11.

An electrically driven motor M which is housed in the body portion 11a of the brake caliper 11 includes a plurality of stator coils 17 fixed to an inner surface of the body portion 11a, a cylindrical motor output shaft 19 which is supported inside the stator coils 17 rotatably around an axis line L with a ball bearing 18, and a plurality of permanent magnets 20 which are fixed to an outer peripheral surface of the motor output shaft 19 to oppose to inner peripheral surfaces of the stator coils 17. A cylindrical female screw member 21 is relatively rotatably supported inside the motor output shaft 19 with a pair of ball bearings 22 and 23. A plurality of balls 25 are disposed between the female screw member 21 and a male screw member 24 which integrally extends on the axis line L from the rear surface of the brake piston 15. The female screw member 21, the male screw member 24 and the balls 25 constitute a ball screw mechanism S.

A planetary gear mechanism P is disposed inside the body portion 11a of the brake caliper 11 so as to connect the electrically driven motor M and the ball screw mechanism S. The planetary gear mechanism P disposed on the axis line L includes a sun gear 31 fixed to the motor output shaft 19, a ratchet wheel 32 which is fixed to the female screw member 21 of the ball screw mechanism S and also serves as a planetary carrier, a ring gear 33 surrounding an outer periphery of the ratchet wheel 32, and a plurality of pinions 35 . . . which are supported at the ratchet wheel 32 via pinion shafts 34 . . . and are concurrently meshed with the sun gear 31 and the ring gear 33. A thrust bearing 36 for supporting a braking reaction force which the brake piston 15 receives from the brake disc 13 is disposed between the ratchet wheel 32 and the inner surface of the body portion 11a.

The electrically driven brake device includes a ratchet mechanism R for causing the electrically driven brake device to function as the electrically driven parking brake device. The ratchet mechanism R includes the ratchet wheel 32, a ratchet pole 42 which is swingably supported at its central portion by a support point pin 41 and has, at its one end portion, a ratchet claw 42a capable of engaging with ratchet teeth 32a of the ratchet wheel 32, a torsion coil spring 43 for biasing the ratchet pole 42 in a direction in which the ratchet claw 42a is released from the ratchet teeth 32a, a solenoid 44 which presses one end side of the ratchet pole 42 to engage the ratchet claw 42a with the ratchet teeth 32a, and a bolt 45 which is manually movable for pressing the other end side of the ratchet pole 42, as a manual release mechanism.

Next, an operation of the embodiment of the present invention having the above-described construction will be described.

When the electrically driven brake device is used as a service brake, the electrically driven motor M is normally driven, the rotation of the motor output shaft 19 is inputted into the sun gear 31 of the planetary gear mechanism P, and the ring gear 33 is fixed to be unable to rotate, so that the rotation of the sun gear 31 is transmitted to the female screw member 21 of the ball screw mechanism S via the pinions 35 and the ratchet wheel 32. When the female screw member 21 rotates, the male screw member 24, which is engaged with the female screw member 21 via the balls 25, moves forward together with the brake piston 15, so that the brake piston 15 makes the brake pads 14a and 14b abut to the brake disc 13 to generate a braking force. When the electrically driven motor M is reversely rotated, the brake piston 15 retreats, and the brake pads 14a and 14b separate from the brake disc 13 to release the braking force.

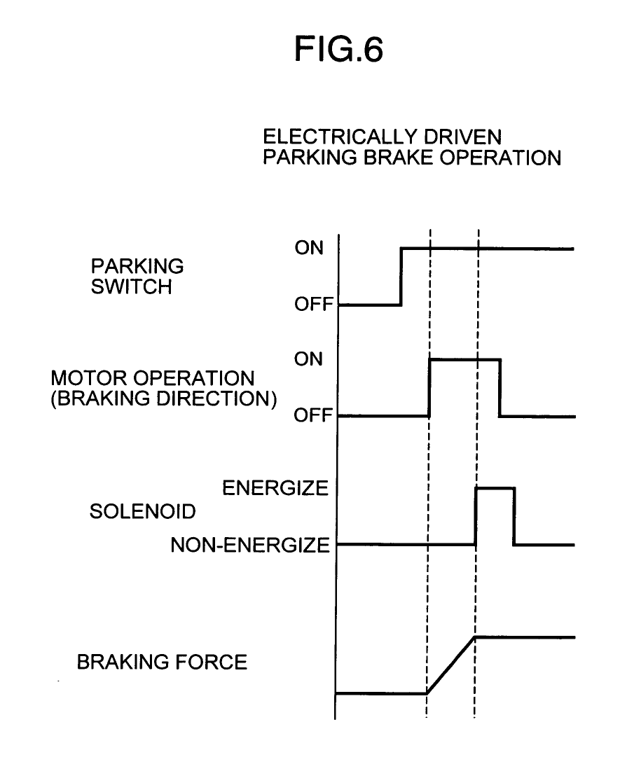

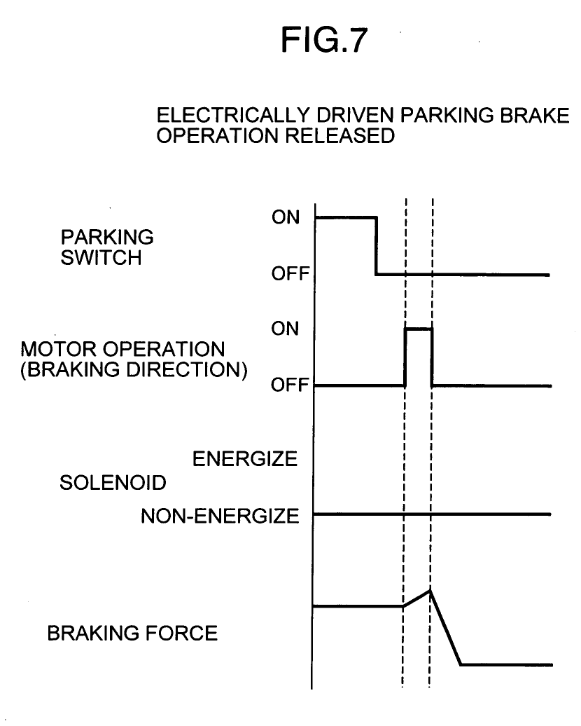

Next, the operation when the electrically driven brake device is used as the electrically driven parking brake will be described with reference to time charts in FIG. 6 and FIG. 7.

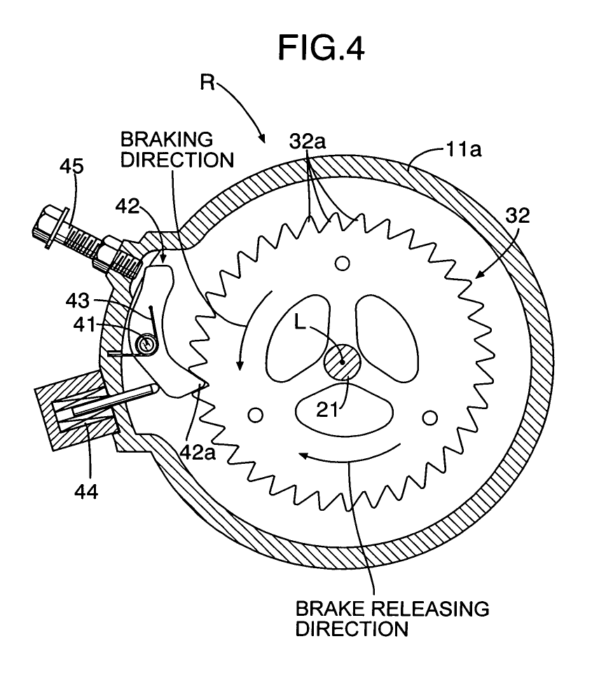

In the time chart in FIG. 6, when the driver turns ON the parking switch, the electrically driven motor M normally rotates and the brake piston 15 moves forward, whereby the braking force is generated with the same operation as in the case of the aforementioned service brake. When a predetermined braking force is generated, the solenoid 44 is energized, and as shown in FIG. 4, the ratchet pole 42 pressed by the solenoid 44 swings in the counterclockwise direction around the support point pin 41 against the resilient force of the torsion coil spring 43, whereby the ratchet claw 42a of the ratchet pole 42 is engaged with the ratchet teeth 32a of the ratchet wheel 32.

When the energization to the electrically driven motor M is stopped in this state, the brake pads 14a and 14b are retreated by the reaction force which the brake pads 14a and 14b receive from the brake disc 13, and the ratchet wheel 32 rotates in the brake releasing direction, whereby the ratchet claw 42a of the ratchet pole 42 is firmly meshed with the ratchet teeth 32a of the ratchet wheel 32. Therefore, the electrically driven parking brake is held in the operating state even when the energization to the solenoid 44 is released.

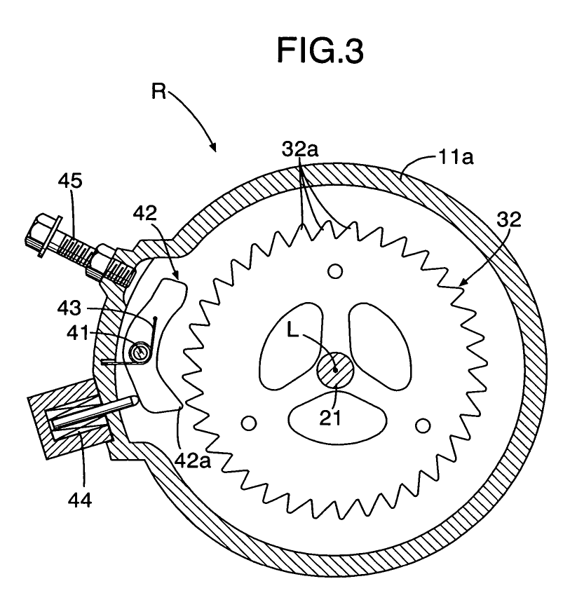

In the time chart in FIG. 7, when the driver turns OFF the parking switch, the electrically driven motor M is driven in the normal rotation direction for only a moment, so that the ratchet wheel 32 slightly rotates in the braking direction. As a result, the ratchet claw 42a of the ratchet pole 42 is released from the ratchet teeth 32a . . . of the ratchet wheel 32, and the ratchet pole 42 is rotated in the clockwise direction to the position in FIG. 3 by the resilient force of the torsion coil spring 43, whereby the restraint of the ratchet wheel 32 is released. Then, the brake pads 14a and 14b are automatically retreated by the reaction force which the brake pads 14a and 14b receive from the brake disc 13, so that the operation of the electrically driven parking brake is released. At this time, the electrically driven motor M may be reversely rotated to assist the reaction force which the brake pads 14a and 14b receive from the brake disc 13.

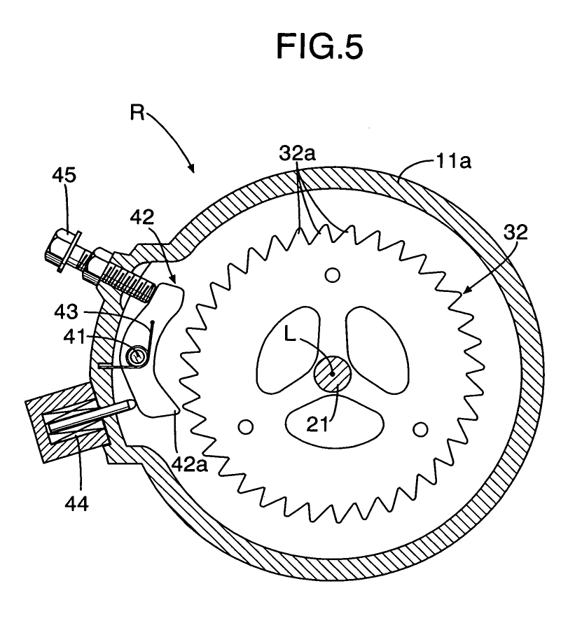

If the electrically driven motor M fails during operation of the electrically driven parking brake, the engagement of the ratchet mechanism R cannot be released and the electrically driven parking brake is held in operation, resulting in a situation where the vehicle cannot travel. In such a case, the bolt 45 may be manually rotated as shown in FIG. 5 to press and swing the ratchet pole 42 in the clockwise direction around the support point pin 41, and the ratchet claw 42a of the ratchet pole 42 can be forcibly released from the ratchet teeth 32a of the ratchet wheel 32. Therefore, the situation in which the operation of the electrically driven parking brake cannot be released can be avoided at the time of an operation failure of the electrically driven motor M, such as a defect in the power supply.

The present embodiment of the invention has been described above, but various changes in design may be made to the present invention without departing from the subject matter of the present invention.

For example, the electrically driven brake device (service brake) is also used as the electrically driven parking brake device in this embodiment, but the present invention is applicable to any exclusive electrically driven parking brake device which is not used as a service brake.

The braking force holding mechanism is not limited to the ratchet mechanism R in this embodiment, but any other suitable mechanism can be adopted.

The manually releasing mechanism is not limited to the bolt 45 in this embodiment, but any other suitable means can be adopted.

1. An electrically driven parking brake device comprising:
a braking member which applies braking force to a braked member rotating with wheels;
an electrically driven motor;
a driving force transmitting mechanism which connects the motor and the braking member, moves the braking member in a braking direction by drive of the motor, and moves the braking member in a brake releasing direction with a reaction force from the braked member;
a braking force holding mechanism which restrains the driving force transmitting mechanism to restrict movement of the braking member in the brake releasing direction;
operation of the braking force holding mechanism being released by driving the motor, when the braking force holding mechanism is operated to restrain the movement of the braking member in the brake releasing direction; and
a manual releasing mechanism which may be manually operated to release the operation of the braking force holding mechanism at a time of failure of the motor.

2. The electrically driven parking brake device according to claim 1, wherein the braking force holding mechanism includes a ratchet pole engageable with a ratchet wheel of the driving force transmitting mechanism, and wherein the manual releasing mechanism comprises a manually movable member which disengages the ratchet pole from the ratchet wheel.

3. The electrically driven parking brake device according to claim 2, wherein the manually movable member is threaded, the ratchet pole is pivotable, and the manually movable member may be rotated into engagement with one portion of the ratchet pole such that another portion of the ratchet pole is disengaged from the ratchet wheel.

4. The electrically driven parking brake device according to claim 2, wherein the manually movable member is disposed with a brake caliper of a wheel.

5. The electrically driven parking brake device according to claim 1, wherein the driving force transmitting mechanism comprises a planetary gear mechanism.

6. The electrically driven parking brake device according to claim 1, wherein the braking force holding mechanism comprises a ratchet mechanism.

7. The electrically driven parking brake device according to claim 1, wherein the braking member, the motor, the driving force transmitting mechanism, the braking force holding mechanism and the manual releasing mechanism are disposed with a brake caliper of a wheel.
